(19) United States
(12) Patent Application Publication
(10) Pub. No.: US 2022/0306847 A1
(43) Pub. Date: Sep. 29, 2022

(54) FLAME-RETARDANT MOISTURE-CROSSLINKABLE COMPOSITIONS

(71) Applicant: Dow Global Technologies LLC, Midland, MI (US)

(72) Inventors: Manish K. Mundra, Collegeville, PA (US); Bharat I. Chaudhary, Collegeville, PA (US)

(21) Appl. No.: 17/293,702

(22) PCT Filed: Dec. 6, 2019
(86) PCT No.: PCT/US2019/064857

§ 371 Date: May 13, 2021

Related U.S. Application Data
(60) Provisional application No. 62/801,684, filed on Feb. 6, 2019.

(51) Int. Cl. C08L 23/08; C08L 71/12; C08L 53/02

(52) U.S. Cl. CPC C08L 23/0869; C08L 71/126; C08L 53/025

(57) ABSTRACT

Moisture-crosslinkable compositions having an alkoxysilane functionalized ethylenic polymer, a polymeric brominated flame retardant, antimony trioxide, and a silanol condensation catalyst. The polymeric brominated flame retardant and the antimony trioxide are present in quantities sufficient to provide a molar ratio of antimony to bromine (Sb/Br) in the range of from 0.79 to 1.70. Additionally, the polymeric brominated flame retardant and the antimony trioxide are present in the composition in a combined amount of greater than 35 wt %. Such moisture-crosslinkable compositions are suitable for use in preparing crosslinked articles of manufacture, such as for wire-and-cable applications.

### FIELD

The present disclosure relates to polyolefin compositions comprising a brominated polymeric flame retardant. This disclosure also relates to wire and cable constructions made from such compositions, in particular those that are moisture cross-linkable.

### INTRODUCTION

Halogenated flame retardants are well known and widely available. These products are used in various polymeric compositions and provide varying levels of flame retardance for various applications such as wires and cables. These products can provide good flame retardance if incorporated at high loadings, but these high loadings make it difficult to achieve a balance of desired properties, e.g., mechanicals (such as crush resistance), electricals (such as wet insulation resistance), and extrusion (such as die pressure observed). Of continued interest are halogenated flame retardants that can provide good flame retardance without the sacrifice, or at least a diminished sacrifice, of other desirable properties.

Alkoxysilane functionalized ethylenic polymers (in combination with appropriate silanol condensation catalysts) are widely employed to make the insulation/jacket layers of low voltage cable constructions (by extrusion processes). Alkoxysilane functionalized ethylenic polymers can be made either by copolymerization of ethylene with suitable alkoxysilanes in a reactor (to make “reactor ethylene silane copolymers,” such as SI-LINK™ AC DFDB-5451 NT or SI-LINK™ DFDA-5451 NT), or by post-reactor grafting of alkoxysilanes to ethylenic polymers. Those alkoxysilane functionalized ethylenic polymers that are made by the latter approach are referred to as “silane grafted ethylenic polymers,” and can be classified as one of the following two types:
1. SIOPLAS™ process (made in a separate step prior to use in the cable extrusion process); or
2. MONOSIL™ process (made in situ during the cable manufacturing process—by one step melt blending, reaction and extrusion of ethylenic polymer compositions containing peroxide, silane and catalyst).

After extrusion, the cables are conditioned at humid conditions in order to effect cros slinking of the polymer layers (to yield adequately low hot creep values, measured at 150° C. or 200° C.). The entire cable construction should demonstrate sufficiently high abuse-resistance properties (in particular, crush resistance). These performance requirements can be particularly challenging to meet when the compositions contain fillers, such as high loadings of flame-retardants.

### SUMMARY

One embodiment is a moisture-crosslinkable composition, comprising, in weight percent (wt %) based on the total weight of the composition:
(a) 25 to 75 wt % alkoxysilane functionalized ethylenic polymer;
(b) 5 to 70 wt % polymeric brominated flame retardant having a weight average molecular weight (Mw) at least 1,000 grams per mole (g/mol);
(c) 5 to 70 wt % antimony trioxide; and
(d) 0.01 to 20 wt % silanol condensation catalyst,
wherein the polymeric brominated flame retardant and the antimony trioxide are present in quantities sufficient to provide a molar ratio of antimony to bromine (Sb/Br) in the range of from 0.79 to 1.70,
wherein the polymeric brominated flame retardant and the antimony trioxide are present in the composition in a combined amount of greater than 35 wt %.

Another embodiment is a moisture-crosslinkable composition, comprising, in weight percent (wt %) based on the total weight of the composition:
(a) 20 to 75 wt % ethylenic polymer;
(b) 0.3 to 5 wt % graftable silane-containing compound;
(c) 0.02 to 1.0 wt % peroxide initiator;
(d) 5 to 70 wt % polymeric brominated flame retardant having a weight average molecular weight (Mw) at least 1,000 grams per mole (g/mol);
(e) 5 to 70 wt % antimony trioxide; and
(f) 0.01 to 20 wt % silanol condensation catalyst,
wherein the polymeric brominated flame retardant and the antimony trioxide are present in quantities sufficient to provide a molar ratio of antimony to bromine (Sb/Br) in the range of from 0.79 to 1.70,
wherein the polymeric brominated flame retardant and the antimony trioxide are present in the composition in a combined amount of greater than 35 wt %.

Yet another embodiment is a moisture-crosslinkable composition, comprising, in weight percent (wt %) based on the total weight of the composition:
(e) 25 to 75 wt % alkoxysilane functionalized ethylenic polymer;
(f) 5 to 70 wt % polymeric brominated flame retardant having a weight average molecular weight (Mw) at least 1,000 grams per mole (g/mol);
(g) 5 to 70 wt % antimony trioxide;
(h) 1 to 10 wt % of a halogen-free flame retardant other than the antimony trioxide; and
(i) 0.01 to 20 wt % silanol condensation catalyst,
wherein the polymeric brominated flame retardant and the antimony trioxide are present in quantities sufficient to provide a molar ratio of antimony to bromine (Sb/Br) in the range of from 0.66 to 1.70,
wherein the polymeric brominated flame retardant and the antimony trioxide are present in the composition in a combined amount of 35 wt % or less,
wherein the polymeric brominated flame retardant, the antimony trioxide, and the halogen-free flame retardant are present in a combined amount of greater than 35 wt %.

Still another embodiment is a moisture-crosslinkable composition, comprising, in weight percent (wt %) based on the total weight of the composition:
(a) 20 to 75 wt % ethylenic polymer;
(b) 0.3 to 5 wt % graftable silane-containing compound;
(c) 0.02 to 1.0 wt % peroxide initiator;
(d) 5 to 70 wt % polymeric brominated flame retardant having a weight average molecular weight (Mw) at least 1,000 grams per mole (g/mol);
(e) 5 to 70 wt % antimony trioxide;
(f) 1 to 10 wt % of a halogen-free flame retardant other than the antimony trioxide; and
(g) 0.01 to 20 wt % silanol condensation catalyst,
wherein the polymeric brominated flame retardant and the antimony trioxide are present in quantities sufficient to provide a molar ratio of antimony to bromine (Sb/Br) in the range of from 0.66 to 1.70,
wherein the polymeric brominated flame retardant and the antimony trioxide are present in the composition in a combined amount of 35 wt % or less,
wherein the polymeric brominated flame retardant, the antimony trioxide, and the halogen-free flame retardant are present in a combined amount of greater than 35 wt %.

### DETAILED DESCRIPTION

The present disclosure concerns moisture-crosslinkable compositions comprising alkoxysilane functionalized ethylenic polymer, polymeric brominated flame retardant, antimony trioxide, and silanol condensation catalyst. Alternatively, the present disclosure concerns moisture-crosslinkable compositions comprising ethylenic polymer, graftable silane-containing compound, peroxide initiator, polymeric brominated flame retardant, antimony trioxide, and silanol condensation catalyst. In either embodiment, the moisture-crosslinkable composition maybe used to make various articles of manufacture, such as sheathing for wire-and-cable applications.

### Definitions

For purposes of United States patent practice, the contents of any referenced patent, patent application or publication are incorporated by reference in their entirety (or its equivalent U.S. version is so incorporated by reference) especially with respect to the disclosure of definitions (to the extent not inconsistent with any definitions specifically provided in this disclosure) and general knowledge in the art.

The numerical ranges disclosed herein include all values from, and including, the lower and upper value. For ranges containing explicit values (e.g., 1 or 2; or 3 to 5; or 6; or 7), any subrange between any two explicit values is included (e.g., 1 to 2; 2 to 6; 5 to 7; 3 to 7; 5 to 6; etc.).

Unless stated to the contrary, implicit from the context, or customary in the art, all parts and percents are based on weight and all test methods are current as of the filing date of this disclosure.

The terms “comprising,” “including,” “having” and their derivatives, are not intended to exclude the presence of any additional component, step or procedure, whether or not the same is specifically disclosed. In order to avoid any doubt, all compositions claimed through use of the term “comprising” may include any additional additive, adjuvant, or compound, whether polymeric or otherwise, unless stated to the contrary. In contrast, the term “consisting essentially of” excludes from the scope of any succeeding recitation any other component, step, or procedure, excepting those that are not essential to operability. The term “consisting of” excludes any component, step, or procedure not specifically delineated or listed. The term “or,” unless stated otherwise, refers to the listed members individually as well as in any combination. Use of the singular includes use of the plural and vice versa.

“Composition” and like terms mean a mixture of materials which comprise the composition, as well as reaction products and decomposition products formed from the materials of the composition.

“Polymer” and like terms mean a macromolecular compound prepared by reacting (i.e., polymerizing) monomers of the same or different type. “Polymer” includes homopolymers and interpolymers. Trace amounts of impurities, for example, catalyst residues, may be incorporated into and/or within the polymer. The term also embraces all forms of copolymer, e.g., random, block, etc. Although a polymer is often referred to as being “made of” one or more specified monomers, “based on” a specified monomer or monomer type, “containing” a specified monomer content, or the like, in this context the term “monomer” is understood to be referring to the polymerized remnant of the specified monomer and not to the unpolymerized species. In general, polymers are referred to has being based on “units” that are the polymerized form of a corresponding monomer.

“Interpolymer” means a polymer prepared by the polymerization of at least two different monomers. This generic term includes copolymers, usually employed to refer to polymers prepared from two different monomers, and polymers prepared from more than two different monomers, e.g., terpolymers, tetrapolymers, etc.

“Polyolefin,” “PO” and like terms mean a polymer derived from simple olefins. Many polyolefins are thermoplastic and for purposes of this disclosure, can include a rubber phase. Representative polyolefins include polyethylene, polypropylene, polybutene, polyisoprene and their various interpolymers.

“Ethylenic polymer,” “ethylene-based polymer,” “ethylene polymer,” “polyethylene” and like terms mean a polymer that contains equal to or greater than 50 weight percent (wt %), or a majority amount, of polymerized ethylene based on the weight of the polymer, and, optionally, may comprise one or more comonomers. The generic term “ethylene-based polymer” thus includes ethylene homopolymer and ethylene interpolymer.

A “conductor” is an element of elongated shape (wire, cable, optical fiber) for transferring energy at any voltage (DC, AC, or transient). The conductor is typically at least one metal wire or at least one metal cable (such as aluminum or copper), but may be optical fiber. The conductor may be a single cable or a plurality of cables bound together (i.e., a cable core, or a core).

A “sheath” is a generic term and when used in relation to cables, it includes insulation coverings or layers, protective jackets and the like.

A “wire” is a single strand of conductive metal, e.g., copper or aluminum, or a single strand of optical fiber.

A “cable” is at least one conductor, e.g., wire, optical fiber, etc., within a protective jacket or sheath. Typically, a cable is two or more wires or two or more optical fibers bound together in a common protective jacket or sheath. Combination cables may contain both electrical wires and optical fibers. The individual wires or fibers inside the jacket or sheath may be bare, covered or insulated. Typical cable designs are illustrated in U.S. Pat. Nos. 5,246,783; 6,496,629; and 6,714,707.

“Crosslinkable,” “curable” and like terms indicate that the polymer, before or after shaped into an article, is not cured or crosslinked and has not been subjected or exposed to treatment that has induced substantial crosslinking although the polymer comprises additive(s) or functionality which will cause, promote or enable substantial crosslinking upon subjection or exposure to such treatment (e.g., exposure to water).

“Moisture-crosslinkable polymeric composition” and like terms mean a composition that comprises a polymer that can be crosslinked upon exposure to humidity or water under appropriate temperature. Typically, one of the polymers in the composition comprises hydrolysable silane groups.

“Hydrolysable silane group” and like terms mean a silane group that will react with water. These include alkoxysilane groups on monomers or polymers that can hydrolyze to yield silanol groups, which in turn can condense to cros slink the monomers or polymers.

“Room temperature” and like terms mean 23° C.

### Ethylenic Polymer Having Hydrolysable Silane Groups

Ethylenic Polymer

The ethylenic polymers used in the practice of this invention can be branched, linear, or substantially linear, and can be made by polymerization or copolymerization in a reactor (low pressure or high pressure) or by post-reactor modification (such as reactive extrusion to make a graft copolymer). As used herein, the term “high-pressure reactor” or “high-pressure process” is any reactor or process operated at a pressure of at least 5,000 pounds per square inch (psi) (34.47 megaPascal or mPa). As known to those of ordinary skill in the art, “branched” ethylenic polymers are often (but not only) prepared in a high-pressure reactor or process and tend to have highly branched polymer structures, with branches found both on the polymer backbones and on the branches themselves. In contrast, “substantially linear” denotes a polymer having a backbone that is substituted with 0.01 to 3 long-chain branches per 1,000 carbon atoms. In some embodiments, the ethylenic polymer can have a backbone that is substituted with 0.01 to 1 long-chain branches per 1,000 carbon atoms, or from 0.05 to 1 long-chain branches per 1,000 carbon atoms.

The ethylenic polymers used in the practice of this invention include both homopolymers and interpolymers, random and blocky copolymers, and functionalized (e.g., ethylene vinyl acetate, ethylene ethyl acrylate, etc.) and non-functionalized polymers. The ethylenic interpolymers include elastomers, flexomers and plastomers. The ethylene polymer comprises at least 50, preferably at least 60 and more preferably at least 80, wt % of units derived from ethylene. The other units of the ethylenic interpolymer are typically derived from one or more polymerizable monomers including (but not limited to) α-olefins and unsaturated esters.

The α-olefin can be a C3-20 linear, branched or cyclic α-olefin. Examples of C3-20 α-olefins include propene, 1-butene, 4-methyl-1-pentene, 1-hexene, 1-octene, 1-decene, 1-dodecene, 1-tetradecene, 1-hexadecene, and 1-octadecene. The α-olefins can also contain a cyclic structure such as cyclohexane or cyclopentane, resulting in an α-olefin such as 3-cyclohexyl-1-propene (allyl cyclohexane) and vinyl cyclohexane. Although not α-olefins in the classical sense of the term, for purposes of this disclosure certain cyclic olefins, such as norbornene and related olefins, particularly 5-ethylidene-2-norbornene, are α-olefins and can be used in place of some or all of the α-olefins described above. Similarly, styrene and its related olefins (for example, a-methylstyrene, etc.) are α-olefins for purposes of this disclosure. Illustrative ethylenic interpolymers include copolymers of ethylene/propylene, ethylene/butene, ethylene/1-hexene, ethylene/1-octene, ethylene/styrene, and the like. Illustrative ethylenic terpolymers include ethylene/propylene/1-octene, ethylene/propylene/butene, ethylene/butene/1-octene, ethylene/propylene/diene monomer (EPDM) and ethylene/butene/styrene.

In various embodiments, the unsaturated esters can be alkyl acrylates, alkyl methacrylates, or vinyl carboxylates. The alkyl groups can have from 1 to 8 carbon atoms, or from 1 to 4 carbon atoms. The carboxylate groups can have from 2 to 8 carbon atoms, or from 2 to 5 carbon atoms. Examples of acrylates and methacrylates include, but are not limited to, ethyl acrylate, methyl acrylate, methyl methacrylate, t-butyl acrylate, n-butyl acrylate, n-butyl methacrylate, and 2 ethylhexyl acrylate. Examples of vinyl carboxylates include, but are not limited to, vinyl acetate, vinyl propionate, and vinyl butanoate.

Examples of ethylenic polymers suitable for use herein include high density polyethylene (HDPE); medium density polyethylene (MDPE); linear low density polyethylene (LLDPE); low density polyethylene (LDPE); very low density polyethylene (VLDPE); homogeneously branched, linear ethylene/α-olefin copolymers (e.g. TAFMER™ by Mitsui Petrochemicals Company Limited and EXACT™ by DEX-Plastomers); homogeneously branched, substantially linear ethylene/α-olefin polymers (e.g., AFFINITY™ polyolefin plastomers and ENGAGE™ polyolefin elastomers available from The Dow Chemical Company); and ethylene block copolymers (INFUSE™ also available from The Dow Chemical Company). The substantially linear ethylene copolymers are more fully described in U.S. Pat. Nos. 5,272,236, 5,278,272 and 5,986,028, and the ethylene block copolymers are more fully described in U.S. Pat. Nos. 7,579,408, 7,355,089 7,524,911, 7,514,517, 7,582,716 and 7,504,347.

Ethylenic interpolymers of particular interest for use herein are LDPE, LLDPE, and HDPE. These ethylenic copolymers are commercially available from a number of different sources including The Dow Chemical Company under such trademarks as DOWLEX™, ATTANE™ and FLEXOMER™. One preferred polymer is linear low-density polyethylene (LLDPE).

They ethylenic polymers can have a melt index (I₂) in the range of 0.1 to 50 grams per 10 minutes (g/10 min.), or 0.3 to 30 g/10 min., or 0.5 to 20 g/10 min. 12 is determined under ASTM D-1238, Condition E and measured at 190° C. and 2.16 kg.

In one embodiment, the ethylenic polymer is of any crystallinity at room temperature. In one embodiment, the crystallinity at room temperature of the ethylenic polymer ranges from 0% to 80%, or 10% to 80%, or 30% to 70%, or 35% to 60%, or 40% to 50%. Crystallinity at room temperature is calculated or measured as described in the Examples.

The ethylenic polymers can be blended or diluted with one or more other polymers to the extent that the polymers of this invention constitute at least about 70, at least about 75, or at least about 80, weight percent of the polymer blend.

Silane Functionality

Any silane (or silane-containing compound) that will effectively copolymerize with ethylene, or graft to an ethylenic polymer, and thus enable crosslinking of the ethylenic polymer, can be used, and those described by the following formula are exemplary:

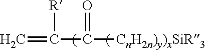

in which R′ is a hydrogen atom or methyl group; x and y are 0 or 1 with the proviso that when x is 1, y is 1; n is an integer from 1 to 12 inclusive, preferably 1 to 4, and each R″ independently is a hydrolyzable organic group such as an alkoxy group having from 1 to 12 carbon atoms (e.g. methoxy, ethoxy, butoxy), aryloxy group (e.g. phenoxy), araloxy group (e.g. benzyloxy), aliphatic acyloxy group having from 1 to 12 carbon atoms (e.g. formyloxy, acetyloxy, propanoyloxy), amino or substituted amino groups (alkylamino, arylamino), or a lower alkyl group having 1 to 6 carbon atoms inclusive, with the proviso that not more than one of the three R″ groups is an alkyl. Such silanes may be copolymerized with ethylene in a reactor, such as a high-pressure process, to make a copolymer of ethylene and a monomer with hydrolyzable silane groups. Such silanes may also be grafted to a suitable ethylenic polymer, such as those described above, by the use of a suitable quantity of organic peroxide, either before or during a shaping or molding operation, to make a silane-grafted ethylenic polymer (Si-g-EP) that has hydrolyzable silane groups.

Suitable silanes include unsaturated silanes that comprise an ethylenically unsaturated hydrocarbyl group, such as a vinyl, allyl, isopropenyl, butenyl, cyclohexenyl or gamma-(meth)acryloxy allyl group, and a hydrolyzable group, such as, for example, a hydrocarbyloxy, hydrocarbonyloxy, or hydrocarbylamino group. Examples of hydrolyzable groups include methoxy, ethoxy, formyloxy, acetoxy, proprionyloxy, and alkyl or arylamino groups. Preferred silanes are the unsaturated alkoxy silanes which can be grafted onto the polymer or copolymerized in-reactor with other monomers (such as ethylene and acrylates). These silanes and their method of preparation are more fully described in U.S. Pat. No. 5,266,627. Vinyl trimethoxy silane (VTMS), vinyl triethoxy silane, vinyl triacetoxy silane, gamma-(meth)acryloxy propyl trimethoxy silane and mixtures of these silanes are the preferred silane crosslinkers for use in this invention.

The amount of silane (“crosslinker”) used to functionalize the ethylenic polymer can vary widely depending upon the nature of the polymer, the silane, the processing or reactor conditions, the grafting or copolymerization efficiency, the ultimate application, and similar factors, but typically at least 0.5, preferably at least 0.7, weight percent is used, based on the combined pre-polymerized weights of the silane and the ethylenic polymer. Considerations of convenience and economy are two of the principal limitations on the maximum amount of silane used, and typically the maximum amount of silane does not exceed 5, or does not exceed 3, weight percent.

The silane is grafted to the ethylenic polymer by any conventional method, typically in the presence of a free radical initiator, e.g. peroxides and azo compounds, or by ionizing radiation, etc. Organic initiators are preferred, such as any one of the peroxide initiators, for example, dicumyl peroxide, di-tert-butyl peroxide, t-butyl perbenzoate, benzoyl peroxide, cumene hydroperoxide, t-butyl peroctoate, methyl ethyl ketone peroxide, 2,5-dimethyl-2,5-di(t-butyl peroxy)hexane, lauryl peroxide, and tert-butyl peracetate. A suitable azo compound is 2,2-azobisisobutyronitrile. The amount of initiator can vary, but it is typically present in an amount of at least 0.02, at least 0.04, or at least 0.06 wt %. Typically, the initiator does not exceed 1.0, does not exceed 0.30, or does not exceed 0.20 wt %. The ratio of silane to initiator also can vary widely, but the typical crosslinker:initiator ratio can be from 0.3:1 to 250:1, from 5:1 to 50:1, from 10:1 to 30:1, or from 13:1 and 24:1.

While any conventional method can be used to graft the silane to the ethylenic polymer, one suitable method involves blending the two with the initiator in the first stage of a reactor extruder, such as a twin screw extruder or BUSS™ kneader. Such a process to make silane-grafted ethylenic polymer (Si-g-EP) is referred to as the SIOPLAS process, in which a silane monomer is grafted onto the backbone of a base ethylenic polymer by a process such as extrusion, prior to the polymer's incorporation into the present composition, as described, for example, in U.S. Pat. Nos. 4,574,133; 6,048,935; and 6,331,597. The grafting conditions can vary, but the melt temperatures are typically between 160 and 260° C., preferably between 190 and 230° C., depending upon the residence time and the half-life of the initiator.

In an embodiment, the silane-functionalized ethylenic polymer is an in-situ Si-g-EP. The in-situ Si-g-EP is formed by a process such as the MONOSIL process, in which a silane monomer is grafted onto the backbone of a base ethylenic polymer during the extrusion of the present composition to form a coated conductor, as described, for example, in U.S. Pat. No. 4,574,133.

Copolymerization of unsaturated alkoxy silane crosslinkers with ethylene and other monomers may be done in a high-pressure reactor that is used in the manufacture of ethylene homopolymers and copolymers with vinyl acetate and acrylates.

In one embodiment in which the moisture-crosslinkable composition comprises an alkoxysilane-functionalized ethylenic polymer, the amount of the alkoxysilane-functionalized polymer in the composition can be from 25 to 75 wt %, or to 70 wt %, or to 65 wt %, or to 60 wt %, or to 55 wt %, or to 50 wt %, based on the entire weight of the moisture-crosslinkable composition.

In one embodiment in which the moisture-crosslinkable composition comprises an alkoxysilane-functionalized ethylenic polymer, the amount of the alkoxysilane-functionalized polymer in the composition can be from 75 to 25 wt %, or to 30 wt %, or to 35 wt %, or to 40 wt %, or to 45 wt %, based on the entire weight of the moisture-crosslinkable composition.

In one embodiment in which the moisture-crosslinkable composition comprises an alkoxysilane-functionalized ethylenic polymer, the amount of the alkoxysilane-functionalized polymer in the composition can be from 30 to 70 wt %, from 35 to 65 wt %, from 40 to 60 wt %, from 45 to 55 wt %, or from 48 to 52 wt %, based on the entire weight of the moisture-crosslinkable composition.

Polymeric Brominated Flame Retardant

The polymeric brominated flame retardants are known compounds and many are commercially available. In one or more embodiments, the brominated flame retardant can have a weight average molecular weight (“Mw”) of at least 1,000 g/mol, at least 10,000 g/mol, at least 25,000 g/mol, at least 50,000 g/mol, at least 75,000 g/mol, or at least 100,000 g/mol. In one or more embodiments, the brominated flame retardant has an Mw up to 1,000,000 g/mol, up to 500,000 g/mol, or up to 200,000 g/mol.

The polymeric brominated flame retardant can be a thermally stable brominated copolymer, the copolymer having polymerized therein a butadiene moiety and a vinyl aromatic monomer moiety, the copolymer having, prior to bromination, a vinyl aromatic monomer content of from 5 to 90 percent by weight, based upon copolymer weight, a 1,2-butadiene isomer content of greater than 0 percent by weight, based upon butadiene moiety weight, and a weight average molecular weight of at least 1,000 g/mol. The brominated copolymer can have an unbrominated, nonaromatic double bond content of less than 50 percent, based upon nonaromatic double bond content of the copolymer prior to bromination as determined by ¹H NMR spectroscopy (that is, greater than 50% of the butadiene repeat units are brominated) and a five percent weight loss temperature (5% WLT), as determined by thermogravimetric analysis (TGA) of at least 200° C. The unbrominated, non-aromatic double bond content is preferably less than or equal to 15 percent, even more preferably less than 10 percent, in each instance based upon nonaromatic double bond content of the copolymer prior to bromination, that is, the proportion of butadiene repeat units that are brominated is preferably at least 85% and more preferably at least 90%.

In one or more embodiments, the brominated copolymer is a brominated butadiene/vinyl aromatic monomer copolymer, particularly a brominated styrene/butadiene block copolymer (Br-SBC). The SBC, prior to bromination, may be any of di-block copolymer (e.g., styrene-butadiene), triblock copolymer (e.g., styrene/butadiene/styrene or SBS), tetrablock copolymer (e.g., styrene/butadiene/styrene/butadiene or SBSB) or multiblock copolymer (e.g., styrene/butadiene/styrene/butadiene/styrene or SBSBS). SBCs may be prepared by any process known in the art including random polymerization with preparation via sequential anionic polymerization or by coupling reactions being preferred. Of the foregoing, brominated triblock copolymers such as SBS block copolymers are especially preferred.

While Br-SBCs may be preferred, the brominated butadiene/vinyl aromatic monomer copolymer may also be a random copolymer prepared by conventional free radical polymerization, or by modifications of anionic polymerization (such as use of polar modifiers) or a graft copolymer prepared by grafting, for example, a polymerized styrene monomer chain onto a polybutadiene homopolymer (PBD) backbone.

Brominated butadiene/vinyl aromatic monomer copolymers, including Br-SBC, and processes for their preparation and use are more fully described in WO 2007/058736.

Non-limiting copolymers used to make the brominated copolymers (i.e. prior to bromination), may have the following properties: an Mw within a range from 1,000 to 200,000, from 2,000 to 180,000, from 5,000 to 160,000, or from 100,000 to 160,000; and a polymerized vinyl aromatic monomer content of at least 5 wt %, or within a range of from 5 wt % to 90 wt %, based upon block copolymer weight; and a measurable 1,2-isomer content, i.e., greater than 0 percent.

Representative brominated flame retardants include, but are not limited to, brominated polystyrene; poly(4-bromostyrene); poly(bromostyrene); brominated natural and synthetic rubber; polyvinyl bromide; poly(vinylidene bromide); poly(2-bromoethyl methacrylate); poly(2,3-dibromopropyl methacrylate); poly(methyl-a-bromoacrylate); butadiene styrene brominated copolymer; those described in WO 2014/014648 A2 and those described in U.S. Pat. No. 5,066,752; and those described in Polymer Degradation and Stability, 25(1):1-9 (1989).

In an embodiment, the polymeric brominated flame retardant has a bromine content greater than 50 weight percent, preferably greater than 55 weight percent and, more preferably greater than 60 weight percent.

In various embodiments in which the moisture-crosslinkable composition comprises a polymeric brominated flame retardant of a weight average molecular weight equal to or greater than 1,000 grams per mole, the amount of the polymeric brominated flame retardant in the composition can be in the range of from 5 to 70 wt %, or to 65 wt %, or to 60 wt %, or to 55 wt %, or to 52 wt %, or to 50 wt %, or to 48 wt %, or to 46 wt %, or to 44 wt %, or to 42 wt %, or to 40 wt %, or to 35 wt %, or to 30 wt %, or to 25 wt %, or to 20 wt %, based on the entire weight of the moisture-crosslinkable composition.

In various embodiments in which the moisture-crosslinkable composition comprises a polymeric brominated flame retardant of a weight average molecular weight equal to or greater than 1,000 grams per mole, the amount of the polymeric brominated flame retardant in the composition can be in the range of from 70 to 5 wt %, or to 10 wt %, or to 25 wt %, or to 30 wt %, or to 35 wt %, or to 40 wt %, or to 45 wt %, or to 50 wt %, or to 55 wt %, or to 60 wt %, based on the entire weight of the moisture-crosslinkable composition.

In various embodiments in which the moisture-crosslinkable composition comprises a polymeric brominated flame retardant of a weight average molecular weight equal to or greater than 1,000 grams per mole, the amount of the polymeric brominated flame retardant in the composition can be in the range of from 10 to 65 wt %, or from 12 to 60 wt %, or from 14 to 50 wt %, or from 16 to 40 wt %, based on the entire weight of the moisture-crosslinkable composition.

Antimony Trioxide

As noted above, the moisture-crosslinkable composition comprises antimony trioxide. Antimony trioxide is commercially available from a variety of manufacturers and distributors, any of which may be suitable for use herein. In an embodiment, the average particle size of the antimony trioxide is 10 microns or less, or 5 microns or less, or 3 microns or less, or 2 microns or less, or 1 micron or less, or 0.5 microns or less.

The amount of antimony trioxide in the moisture-crosslinkable composition can be in the range of from 5 to 70 wt %, or to 65 wt %, or to 60 wt %, or to 55 wt %, or to 52 wt %, or to 50 wt %, or to 48 wt %, or to 46 wt %, or to 44 wt %, or to 42 wt %, or to 40 wt %, or to 35 wt %, or to 30 wt %, or to 25 wt %, or to 20 wt %, based on the entire weight of the moisture-crosslinkable composition.

In various embodiments the amount of antimony trioxide in the moisture-crosslinkable composition can be in the range of from 70 to 5 wt %, or to 10 wt %, or to 25 wt %, or to 30 wt %, or to 35 wt %, or to 40 wt %, or to 45 wt %, or to 50 wt %, or to 55 wt %, or to 60 wt %, based on the entire weight of the moisture-crosslinkable composition.

In various embodiments the amount of antimony trioxide in the moisture-crosslinkable composition can be in the range of from 10 to 65 wt %, or from 12 to 60 wt %, or from 14 to 50 wt %, or from 15 to 47 wt %, based on the entire weight of the moisture-crosslinkable composition.

In various embodiments, the antimony trioxide and the polymeric brominated flame retardant are present in the moisture-crosslinkable composition in combined amounts of at least 35 wt %, or at least 40 wt %, based on the total weight of the moisture-crosslinkable composition. The antimony trioxide and polymeric brominated flame retardant may be present in combined amounts up to 90 wt %, up to 85 wt %, or up to 80 wt %, based on the total weight of the moisture-crosslinkable composition.

In various embodiments, the antimony trioxide and the polymeric brominated flame retardant are present in the moisture-crosslinkable composition in quantities sufficient to provide a molar ratio of antimony to bromine (Sb/Br) in the range of from 0.79 to 1.70, or from 0.95 to 1.22. The Sb/Br molar ratio is calculated in accordance with the following Equation (1):

$$Sb : Br molar ratio = \frac{moles of antimony in composition}{moles of bromine in composition} . \qquad Equation ( 1 )$$

The number of moles of antimony (Sb) from the antimony trioxide (Sb₂O₃) is calculated in accordance with the following Equation (1A):

$$moles of antimony in composition = \frac{( grams {Sb}_{2} {O}_{3} in composition \times 0.835345774 )}{121.76} . \qquad Equation ( 1 A )$$

The number of moles of bromine from the brominated flame retardant is calculated in accordance with the following Equation (1B):

$$moles of bromine in composition = \frac{( grams of bromine in composition )}{79.904} . \qquad Equation ( 1 B )$$

The grams of bromine in the composition will depend on the bromine content of the brominated flame retardant.

Silanol Condensation Catalyst

As noted above, the moisture-crosslinkable composition includes a silanol condensation catalyst to promote crosslinking and ensure moisture cure. Silanol condensation catalysts known in the art for crosslinking alkoxysilane polymers can be employed for the compositions described herein. Such catalysts include organic bases, carboxylic acids and organometallic compounds including organic titanates and complexes or carboxylates of lead, cobalt, iron, nickel, zinc and tin, such as dibutyltindilaurate, dioctyltinmaleate, dibutyltindiacetate, dibutyltindioctoate, stannous acetate, stannous octoate, lead naphthenate, zinc caprylate, cobalt naphthenate; and the like. Tin carboxylates, especially dibutyltindilaurate and dioctyltinmaleate, are particularly useful silanol condensation catalysts for the compositions described herein. The silanol condensation catalyst may be present in an amount from 0.01 to 20 wt %, or from 0.025 to 10 wt %, or from 0.05 to 5 wt %, or from 0.1 to 3 wt %, based on the total weight of the composition. The silanol condensation catalyst may be introduced in the form of a masterbatch. In one embodiment the silanol condensation catalyst is a component of a masterbatch in an amount greater than 0 wt % and preferably less than 40 wt %.

Fillers and Additives

The crosslinked, silane-functionalized polyolefin product can be filled or unfilled. If filled, then the amount of filler present should preferably not exceed an amount that would cause unacceptably large degradation of the mechanical and/or chemical properties of the silane-crosslinked, olefin polymer. Typically, the amount of filler present is between 2 and 80 wt %, preferably between 5 and 70 wt %, based on the weight of the polymer. Representative fillers include kaolin clay, magnesium hydroxide, silica, calcium carbonate and carbon blacks. The filler may or may not have flame retardant properties. The filler may be coated with a material that will prevent or retard any tendency that the filler might otherwise have to interfere with the silane cure reaction. Stearic acid is illustrative of such a filler coating. Filler and catalyst are selected to avoid any undesired interactions and reactions, and this selection is well within the skill of the ordinary artisan.

The compositions described herein may also contain additives such as, for example, antioxidants (e.g., hindered phenols such as, for example, IRGANOX™ 1010), phosphites (e.g., IRGAFOS™ 168), UV stabilizers, cling additives, light stabilizers (such as hindered amines), plasticizers (such as dioctylphthalate or epoxidized soy bean oil), metal deactivators, scorch inhibitors, mold release agents, tackifiers (such as hydrocarbon tackifiers), waxes (such as polyethylene waxes), processing aids (such as oils, organic acids such as stearic acid, metal salts of organic acids), oil extenders (such as paraffin oil and mineral oil), colorants or pigments to the extent that they do not interfere with desired physical or mechanical properties of the compositions of the present invention. These additives are used in amounts known to those versed in the art.

The compositions described herein may also contain additional polymeric components. For instance, the composition may contain one or more of the ethylenic polymers described above, yet not modified by a hydrolyzable silane-containing compound. In various embodiments, the compositions described herein can include an ethylenic polymer that contains unsaturated ester, such as, for example, an acrylate (e.g., ethyl acrylate). A suitable example of such an ethylenic polymer is AMPLIFY™ EA 100, which is an ethylene-ethyl acrylate copolymer commercially available from The Dow Chemical Company, Midland, Mich., USA.

When present, the non-silane-containing ethylenic polymer can be present in an amount ranging from 1 to 50 wt %, from 2 to 25 wt %, from 2 to 20 wt %, from 5 to 15 wt %, or from 8 to 12 wt %, based on the total weight of the moisture-crosslinkable composition.

Additional Halogen-Free Flame Retardants

In addition to the antimony trioxide described above, the compositions described herein may comprise at least one other halogen-free flame retardant (HFFR) that can inhibit, suppress, or delay the production of flames. The halogen-free flame retardants may be inorganic materials. Examples of the halogen-free flame retardants suitable for use in compositions according to this disclosure include, but are not limited to, metal hydroxides, red phosphorous, silica, alumina, titanium oxide, carbon nanotubes, talc, clay, organo-modified clay, calcium carbonate, zinc borate, zinc oxide, zinc stearate, wollastonite, mica, ammonium octamolybdate, frits, hollow glass microspheres, intumescent compounds, expanded graphite, and combinations thereof. In an embodiment, the halogen-free flame retardant can be selected from the group consisting of aluminum hydroxide, magnesium hydroxide, calcium carbonate, and combinations thereof. In other embodiments, the moisture-crosslinkable composition is free from any other flame retardants, including any halogen-free flame retardants, besides the polymeric brominated flame retardants and the antimony trioxide described above.

The halogen-free flame retardant, if present, can optionally be surface treated (coated) with a saturated or unsaturated carboxylic acid having 8 to 24 carbon atoms, or 12 to 18 carbon atoms, or a metal salt of the acid. Exemplary surface treatments are described in U.S. Pat. Nos. 4,255,303, 5,034,442 and 7,514,489, US Patent Publication 2008/0251273, and WO 2013/116283. Alternatively, the acid or salt can be merely added to the composition in like amounts rather than using the surface treatment procedure. Other surface treatments known in the art may also be used including silanes, titanates, phosphates and zirconates.

Commercially available examples of halogen-free flame retardants suitable for use in compositions according to this disclosure include, but are not limited to APYRAL™ 40CD available from Nabaltec AG, MAGNIFIN™ H5 available from Magnifin Magnesiaprodukte GmbH & Co KG, and combinations thereof.

In one embodiment the composition described herein comprises at least one zinc compound, including (but not limited to) zinc oxide, zinc stearate, zinc borate, zinc molybdate, and zinc sulfide.

In one embodiment the total halogen-free flame retardant (excluding antimony trioxide) may comprise 1 to 80 wt %, or 1 to 50 wt %, or 1 to 20 wt %, or 1 to 10 wt %, or 2 to 10 wt %, or 3 to 7 wt % of the composition.

If a third flame retardant, such as another halogen-free flame retardant, is included in the composition, it may be possible to lower the total loading of the antimony trioxide and polymeric brominated flame retardant and still achieve VW-1 passing results. In such instances, the molar ratio of antimony to bromine (Sb/Br) may be outside the range of from 0.79 to 1.70, and/or the polymeric brominated flame retardant and the antimony trioxide may be present in the composition in a combined amount of 35 wt % or less. In an embodiment, the molar ratio of antimony to bromine (Sb/Br) can be less than 0.79, the polymeric brominated flame retardant and the antimony trioxide are present in the composition in a combined amount of 35 wt % or less, when a halogen-free flame retardant (e.g., zinc oxide) is present in the composition in an amount of at least 1 wt %, at least 2 wt %, or at least 5 wt %, or at least 10 wt %, and up to 20 wt %.

In an embodiment, the halogen-free flame retardant can be present in an amount ranging from 1 to 10 wt %, from 2 to 10 wt %, or from 3 to 7 wt %. In such embodiments, the combined weight of the polymeric brominated flame retardant, the antimony trioxide, and the halogen-free flame retardant (e.g., zinc oxide) can be greater than 35 wt %, or at least 40 wt %. In various embodiments, the combined weight of the polymeric brominated flame retardant, the antimony trioxide, and the halogen-free flame retardant (e.g., zinc oxide) is in the range of from greater than 35 wt % up to 45 wt %, or up to 40 wt %. In an embodiment, the halogen-free flame retardant is a zinc compound. In an embodiment, the halogen-free flame retardant is zinc oxide.

Compounding/Fabrication

Compounding of the alkoxysilane functionalized polyolefin, polymeric brominated flame retardant, antimony trioxide, silanol condensation catalyst, and optional filler and additives can be performed by standard means known to those skilled in the art. Examples of compounding equipment are internal batch mixers, such as a BANBURY™ or BOLLING™ internal mixer. Alternatively, continuous single or twin screw mixer or extruders can be used, such as a FARREL™ continuous mixer, a WERNER and PFLEIDERER™ twin screw mixer, or a BUSS™ kneading continuous extruder. The type of mixer utilized, and the operating conditions of the mixer, will affect properties of the composition such as viscosity, volume resistivity, and extruded surface smoothness.

The components of the composition are typically mixed at a temperature and for a length of time sufficient to fully homogenize the mixture but insufficient to cause the material to gel. The catalyst is typically added to silane-functionalized polyolefin but it can be added before, with or after the additives, if any. Typically, the components are mixed together in a melt-mixing device. The mixture is then shaped into the final article. The temperature of compounding and article fabrication should be above the melting point of the silane-functionalized polyolefin but below 250° C.

In some embodiments, either or both of the catalyst and the additives are added as a pre-mixed masterbatch. Such masterbatches are commonly formed by dispersing the catalyst and/or additives into an inert plastic resin, e.g., a low-density polyethylene. Masterbatches are conveniently formed by melt compounding methods.

In one embodiment, one or more of the components are dried before compounding, or a mixture of components is dried after compounding, to reduce or eliminate potential scorch that may be caused from moisture present in or associated with the component, e.g., filler. In one embodiment, crosslinkable alkoxysilane functionalized polyolefin mixtures are prepared in the absence of a crosslinking, i.e., condensation, catalyst for extended shelf life, and the crosslinking catalyst is added as a final step in the preparation of a melt-shaped article.

Moisture-Crosslinked Compositions

The compositions described herein can exhibit at least one, or at least two, or at least three, or at least four, or all five, of the following properties after melt blending, fabrication and crosslinking in a humid environment at temperatures below 100° C., such as 4 hours (h) or more of cure (aging) in a 90° C. water bath:
(A) Horizontal burn performance: Total char less than (<) 100 millimeters (mm), more preferably <75 mm, most preferably <40 mm;
(B) Horizontal burn performance: Time to extinguish <80 seconds (s), preferably <40 s, more preferably <20 s, most preferably <10 s;
(C) Wet Insulation Resistance: greater than (>) 100 mega-ohm (Mohm), more preferably >1000 Mohm;
(D) Hot creep: <175%, preferably <100%, more preferably <75%, most preferably <50%;
(E) Passing VW-1 burn test: UL 44 VW-1 procedure where the wire does not burn the flag and the ignition time during each cycle is equal to or less than 60 seconds.

Articles of Manufacture

In one embodiment, the composition of this invention can be applied to a cable as a sheath, semiconductor or insulation layer, in known amounts and by known methods (for example, with the equipment and methods described in U.S. Pat. Nos. 5,246,783 and 4,144,202). Typically, the composition is prepared in a reactor-extruder equipped with a cable-coating die and after the components of the composition are formulated, the composition is extruded over the cable as the cable is drawn through the die. Cure may begin in the reactor-extruder. While not necessary or preferred, the shaped article or cable can be exposed to either or both elevated temperature and external moisture and if an elevated temperature, it is typically between ambient and up to but below the melting point of the polymer for a period of time such that the article reaches a desired degree of crosslinking. The temperature of any post-shaping cure should be above 0° C. In an embodiment, the shaped article is cured (aged) for at least 4 hours in a 90° C. water bath. Other articles of manufacture that can be prepared from the polymer compositions of this invention include fibers, ribbons, sheets, tapes, tubes, pipes, weather-stripping, seals, gaskets, hoses, foams, footwear and bellows. These articles can be manufactured using known equipment and techniques.

As an alternative or addition to moisture crosslinking, the compositions may also be crosslinked by other means such as (but not limited to) hydroxyl terminated polydimethylsiloxane, peroxides, irradiation, and bis-sulfonyl azides.

Cable sheaths prepared from crosslinked compositions described herein can pass the VW-1 flame rating test as well as the horizontal burn test, both conducted in accordance with UL-2556.

### Test Methods

### Density

Measure density according to ASTM D-792, Method B.

Melt index

Melt index (I₂), is measured in accordance with ASTM D1238, condition 190° C./2.16 kg, and is reported in grams eluted per 10 minutes.

### Hot Creep

Hot creep is measured in accordance with UL-2556 Section 7.9 for conductor sizes of 8 AWG or smaller. Tests are conducted on insulation and/or jacket layers that have been removed (stripped) from conductors. Two marks spaced 25 mm apart are made on a sample. The sample is then placed into an oven at 150° C. under a load of 20 N/cm² (0.2 MPa) for 15 minutes. The distance between the initial marks is re-measured and the hot creep elongation is recorded.

### Wet Insulation Resistance (wet IR)

Wet insulation resistance (IR) is measured in accordance with UL-44. Wet IR is measured on a coiled moisture cured coated conductor (14 AWG copper wire with 30 mil coating thickness), of which a 10 ft (3.048 meter) length of wire is immersed in an electrical water bath at 90° C. The wire is connected to a megohmmeter in a manner such that the water is one electrode and the wire conductor is the other electrode. In that manner, the direct current (DC) electrical resistance of the coating is measured with 500 V applied. The initial measurement is taken after 6-24 hours of submersion, and all subsequent measurements are taken on a 7-day frequency for a period of typically up to 36 weeks, while the sample is aged under 600 V alternating current (AC).

### Tensile Strength and Elongation at Break (T&E)

Tensile strength (peak stress or stress at break) and elongation at break are measured in accordance with UL 2556 Section 3.5 using an Instron model 4201. Three to five samples are prepared from the finished wire by removing the insulation from the conductor without damaging the polymer sheath. The testing conditions are 20 inches per minute crosshead speed, 2.5 inch jaw span with a 100 pound load cell. Tensile stress at break is recorded in pounds per square inch (psi). Tensile elongation is recorded as a percentage.

### Crush Resistance

Crush resistance is measured in accordance with Section 620 of UL-1581, or Section 7.11 of UL 2556 (condition: 14 AWG (American Wire Gauge)). The result is recorded in pound-force (lbf). The average of ten measurements is reported. The reported crush resistance values are the ultimate values, not those from an initial peak (if any exists).

### VW-1 Burn Performance

VW-1 Burn Performance is measured by subjecting 3 or 5 cured samples for a specific formulation to the protocol of UL 2556 Section 9.4. This involves 5, 15 second applications of a 125 mm flame impinging on at an angle 20° on a vertically oriented specimen 610 mm (24 in) in length. A strip of kraft paper 12.5±1 mm (0.5±0.1 in) is affixed to the specimen 254±2 mm (10±0.1 in) above the impingement point of the flame. A continuous horizontal layer of cotton is placed on the floor of the test chamber, centered on the vertical axis of the test specimen, with the upper surface of the cotton being 235±6 mm (9.25±0.25 in) below the point at which the tip of the blue inner cone of the flame impinges on the specimen. Test failure is based upon the criteria of either burning the 25% of the kraft paper tape flag, ignition of the cotton batting or if the specimen burns longer than 60 seconds on any of the 5 flame applications. As an additional measure of burn performance, the length of uncharred insulation is measured at the completion of the test.

### Materials

AMPLIFY™ EA 100 Functional Polymer is an ethylene-ethyl acrylate copolymer of 15 wt % ethyl acrylate content having a density of 0.930 g/cm³, a melt index (I₂) of 1.3 g/10 min., and is commercially available from The Dow Chemical Company, Midland, Mich., USA.

SI-LINK™ DFDA-5451 NT is an ethylene-silane copolymer having a density of 0.922 g/cm³, a melt index (I₂) of 1.5 g/10 min, and is commercially available from The Dow Chemical Company, Midland, Mich., USA.

SI-LINK™ DFDA-5481 NT is a catalyst masterbatch containing a blend of 1-butene/ethene polymer, ethene homopolymer, phenolic compound antioxidant, dibutyltin dilaurate (DBTDL) (a silanol condensation catalyst), and a phenolic hydrazide compound.

EMERALD Innovation™ 1000 is a brominated polyphenyl ether available from Great Lake Solutions. It has a bromine content of 78 wt % and is of relatively high-molecular weight.

EMERALD Innovation™ 3000 is a brominated styrene/butadiene block copolymer available from Lanxess. It has a bromine content is 64 wt % and Mw from 100,000 to 160,000 g/mol.

MICROFINE™ AO9 is standard grade antimony trioxide available from Great Lakes (Chemtura Group).

MB 54 is a masterbatch containing 97 wt % AMPLIFY™ EA 100 Functional Polymer and 3 wt % of CHIMASORB™ 119, a hindered amine light stabilizer available from BASF.

IRGANOX™ 1010 is a sterically hindered phenolic primary antioxidant, i.e., pentaerythritol tetrakis(3-(3,5-di-tert-butyl-4-hydroxyphenyl)propionate), available from BASF. Zinc Oxide (ZnO) is commercially available from Zochem Inc. as ZOCO 104 and is used as received.

### Test Specimen Preparation

Protocol for Preparing Compositions listed in Table 1 in a Mixing Bowl

The compositions are prepared using a 420 mL BRABENDER™ mixing bowl with cam rotors. The batch mass is calculated to provide 70% fill of the mixing bowl with the flame-retardant formulations. The mixing bowl is pre-heated to a set temperature of 125° C. and the rotor speed set to 25 revolutions per minute (rpm). Half of the polymer is added to the bowl and fluxed until a polymer melt is formed. Next, the flame retardant is added and incorporated into the polymer melt. The remaining amounts of polymers and antioxidants are then added and the rotor speed is increased to 40 rpm. The batch is allowed to flux for an additional 5 minutes. Upon removal from the mixing bowl the formulation is placed in a cold press for 5 minutes. The resulting plaque is cut into smaller pieces which are placed in a 8 inch×8 inch×150 mil mold and compression molded at the following conditions: 125° C. for 5 minutes at 500 psi, followed by 2500 psi for 5 minutes, and subsequently slow cooling at this pressure until the mold temperature reaches 40° C. The compression molded plaque is then guillotined into strips and placed in a Wiley mill to produce small chips. The chips are then fed to a BRABENDER™ model Prep Mixer/Measuring Head laboratory electric batch mixer equipped with 24:1 extruder. A 24:1 Maddox mixing head screw is employed to convey and melt the polymer through a stranded die (at 40 rpm screw speed, using a 20/40/60/20 mesh screen pack and a flat set temperature profile of 140° C. across zone 1, zone 2, zone 3 and die). The strand extrudate is again Wiley milled to produce pellets. These compositions are all thermoplastic and can be used to make thermoplastic flame-retardant sheaths of wire constructions, as well as flame-retardant masterbatches in blends with other components.

Protocol for Preparing Test Specimens

A 3-zone barrel, 25:1 L/D (length to diameter), 3/4″ BRABENDER™ extruder with a 0.050 inch tip and a 0.125 die is used with a 3:1 compression ratio screw with MADDOX™ mixing head. A breaker plate and 40 mesh screen pack are used. The bare copper conductor is 14 AWG/single strand with nominal diameter of 0.064 inches. The zone temperatures are set at 150° C. for all zones including the die. Wire coated samples are immediately cooled in a water trough that resides 4-5 inches from die.

Vacuum dried samples are extruded with a screw speed ranging of 40 rpm. Coated wire (cable) samples are collected on a moving conveyor belt. The conveyor belt speed is set at about 8 feet per minute. The belt is adjusted to obtain a target diameter of 0.124 inches which means a wire coating thickness of approximately 0.030 inches or 30 mils. A minimum of 60 feet of coated wire (cable) samples are collected of each sample for further testing and evaluation.

### EXAMPLES

Prepare seventeen flame-retardant masterbatches according to the formulas provided in Table 1, below. The masterbatches are prepared according to the procedures provided above. Next, prepare four Inventive Samples (IS1-IS4) and 15 Comparative Samples (CS1-CS15) by combining the various flame-retardant masterbatches described in Table 1 with an alkoxysilane functionalized ethylenic polymer according to the formulations provided in Table 2, below. The cable specimens are cured (aged) for 16 hours in a 90° C. water bath to effect crosslinking. All values provided in Tables 1 and 2 are in weight percent. Thereafter, prepare the samples for analysis and analyze the Inventive Samples and Comparative Samples according to the Test Methods provided above. Results are provided in Tables 3 and 4 respectively, below.

TABLE 1
Thermoplastic Flame Retardant Masterbatch Formulations

| | MB | MB | MB | MB | MB | MB | MB | MB | MB |
|---|---|---|---|---|---|---|---|---|---|
| | 1 | 2 | 3 | 4 | 5 | 6 | 7 | 8 | 9 |
| AMPLIFY ® | 19.55 | 19.55 | 19.55 | 19.55 | 19.55 | 19.55 | 19.55 | 19.55 | 19.55 |
| EA 100 | | | | | | | | | |
| Emerald | 32.94 | 37.89 | 39.57 | 32.94 | 60.00 | 41.90 | 45.22 | 48.00 | 50.37 |
| Innovation | | | | | | | | | |
| 3000 | | | | | | | | | |
| Emerald | — | — | — | — | — | — | — | — | — |
| Innovation | | | | | | | | | |
| 1000 | | | | | | | | | |
| Microfine | 47.06 | 42.11 | 30.43 | 47.06 | 20 | 38.10 | 34.78 | 32.00 | 29.63 |
| AO9 | | | | | | | | | |
| ZnO | — | — | 10.00 | — | — | — | — | — | — |
| MB54 | 0.40 | 0.40 | 0.40 | 0.40 | 0.40 | 0.40 | 0.40 | 0.40 | 0.40 |
| Irganox | 0.05 | 0.05 | 0.05 | 0.05 | 0.05 | 0.05 | 0.05 | 0.05 | 0.05 |
| 1010 | | | | | | | | | |
| Total: | 100 | 100 | 100 | 100 | 100 | 100 | 100 | 100 | 100 |
| | MB | MB | MB | MB | MB | MB | MB | MB | MB |
| | 10 | 11 | 12 | 13 | 14 | 15 | 16 | 17 | 18 |
| AMPLIFY ® | 19.55 | 19.55 | 19.55 | 19.55 | 19.55 | 19.55 | 64.55 | 49.55 | 34.55 |
| EA 100 | | | | | | | | | |
| Emerald | 53.33 | 60.00 | — | 7.27 | 18.46 | 26.67 | — | — | — |
| Innovation | | | | | | | | | |
| 3000 | | | | | | | | | |
| Emerald | — | — | — | — | — | — | 15.00 | 30.00 | 45.00 |
| Innovation | | | | | | | | | |
| 1000 | | | | | | | | | |
| Microfine | 26.67 | 20.00 | 80.00 | 72.73 | 61.54 | 53.33 | 20.00 | 20.00 | 20.00 |
| AO9 | | | | | | | | | |
| ZnO | — | — | — | — | — | — | — | — | — |
| MB54 | 0.40 | 0.40 | 0.40 | 0.40 | 0.40 | 0.40 | 0.40 | 0.40 | 0.40 |
| Irganox | 0.05 | 0.05 | 0.05 | 0.05 | 0.05 | 0.05 | 0.05 | 0.05 | 0.05 |
| 1010 | | | | | | | | | |
| Total: | 100 | 100 | 100 | 100 | 100 | 100 | 100 | 100 | 100 |

TABLE 2
Moisture-Crosslinkable Formulations

| | IS | IS | IS | IS | CS | CS | CS | CS | CS | CS | CS | CS | CS | CS | CS | CS | CS | CS | CS | CS |
|---|---|---|---|---|---|---|---|---|---|---|---|---|---|---|---|---|---|---|---|---|
| | 1 | 2 | 3 | 4 | 1 | 2 | 3 | 4 | 5 | 6 | 7 | 8 | 9 | 10 | 11 | 12 | 13 | 14 | 15 | 16 |
| DFDA-5451 | 45 | 45 | 45 | 25 | 45 | 45 | 45 | 45 | 45 | 45 | 45 | 45 | 45 | 45 | 45 | 45 | 45 | 45 | 65 | 55 |
| MB 1 | 50 | — | — | — | — | — | — | — | — | — | — | — | — | — | — | — | — | — | — | — |
| MB 2 | — | 50 | — | — | — | — | — | — | — | — | — | — | — | — | — | — | — | — | — | — |
| MB 3 | — | — | 50 | — | — | — | — | — | — | — | — | — | — | — | — | — | — | — | — | — |
| MB 4 | — | — | — | 70 | — | — | — | — | — | — | — | — | — | — | — | — | — | — | 30 | 40 |
| MB 5 | — | — | — | — | 50 | — | — | — | — | — | — | — | — | — | — | — | — | — | — | — |
| MB 6 | — | — | — | — | — | 50 | — | — | — | — | — | — | — | — | — | — | — | — | — | — |
| MB 7 | — | — | — | — | — | — | 50 | — | — | — | — | — | — | — | — | — | — | — | — | — |
| MB 8 | — | — | — | — | — | — | — | 50 | — | — | — | — | — | — | — | — | — | — | — | — |
| MB 9 | — | — | — | — | — | — | — | — | 50 | — | — | — | — | — | — | — | — | — | — | — |
| MB 10 | — | — | — | — | — | — | — | — | — | 50 | — | — | — | — | — | — | — | — | — | — |
| MB 11 | — | — | — | — | — | — | — | — | — | — | 50 | — | — | — | — | — | — | — | — | — |
| MB 12 | — | — | — | — | — | — | — | — | — | — | — | 50 | — | — | — | — | — | — | — | — |
| MB 13 | — | — | — | — | — | — | — | — | — | — | — | — | 50 | — | — | — | — | — | — | — |
| MB 14 | — | — | — | — | — | — | — | — | — | — | — | — | — | 50 | — | — | — | — | — | — |
| MB 15 | — | — | — | — | — | — | — | — | — | — | — | — | — | — | 50 | — | — | — | — | — |
| MB 16 | — | — | — | — | — | — | — | — | — | — | — | — | — | — | — | 50 | — | — | — | — |
| MB 17 | — | — | — | — | — | — | — | — | — | — | — | — | — | — | — | — | 50 | — | — | — |
| MB 18 | — | — | — | — | — | — | — | — | — | — | — | — | — | — | — | — | — | 50 | — | — |
| DFDA-5481 | 5 | 5 | 5 | 5 | 5 | 5 | 5 | 5 | 5 | 5 | 5 | 5 | 5 | 5 | 5 | 5 | 5 | 5 | 5 | 5 |
| Cat MB | | | | | | | | | | | | | | | | | | | | |
| Total: | 100 | 100 | 100 | 100 | 100 | 100 | 100 | 100 | 100 | 100 | 100 | 100 | 100 | 100 | 100 | 100 | 100 | 100 | 100 | 100 |

TABLE 3
Properties of Inventive Formulations

| | IS | IS | IS | IS |
|---|---|---|---|---|
| | 1 | 2 | 3 | 4 |
| Molar Ratio Sb/Br | 1.22 | 0.95 | 0.66 | 1.22 |
| Combined wt % of | 40 | 40 | 35 | 56 |
| Sb and Br flame | | | | |
| retardant | | | | |

Crush Analysis:

| | | | | |
|---|---|---|---|---|
| Average Crush, lbf | 1802.9 | 1802.6 | 1781 | — |
| Std. Dev. | 0.8 | 1.6 | 50.1 | — |

VW-1 Analysis:

| | | | | |
|---|---|---|---|---|
| Total Flame | 35.3 | 43.3 | 19.0 | 11.5 |
| Duration (sec) | | | | |
| Ignite Cotton | 0/3 | 0/3 | 0/3 | 1/6 |
| (#yes/total) | | | | |
| Average Uncharred | 92 | 90 | 73.3 | 98.3 |
| (mm) | | | | |
| Pass/Fail | Pass | Pass | Pass | Pass |

T&E Analysis:

| | | | | |
|---|---|---|---|---|
| Average Peak | 1801 | 1947 | 1763 | — |
| Stress (psi) | | | | |
| Average Elongation | 58 | 50 | 45 | — |
| at Break (%) | | | | |
| Average Secant | 25740 | 29177 | 24950 | — |
| Modulus (psi) | | | | |
| Hot Creep (%) | 10.39 | 22.32 | 11.81 | |

Wet IR on 30 mil wires at 75° C.:

| | | | | |
|---|---|---|---|---|
| 1 Day | 1.75E+10 | 1.63E+10 | — | — |
| 7 Days | 1.27E+10 | 1.18E+10 | — | — |
| 14 Days | 9.76E+9 | 1.05E+10 | — | — |

TABLE 4
Properties of Comparative Formulations

| | CS | CS | CS | CS | CS | CS | CS | CS |
|---|---|---|---|---|---|---|---|---|
| | 1 | 2 | 3 | 4 | 5 | 6 | 7 | 8 |
| Molar Ratio | 0.29 | 0.78 | 0.66 | 0.57 | 0.50 | 0.43 | 0.29 | — |
| Sb/Br | | | | | | | | |
| Combined wt % | 40 | 40 | 40 | 40 | 40 | 40 | 40 | 40 |
| of Sb and Br | | | | | | | | |
| flame retardant | | | | | | | | |

Crush Analysis:

| | | | | | | | | |
|---|---|---|---|---|---|---|---|---|
| Avg. Crush, lbf | 1603 | 1791 | 1803 | 1802 | 1803 | 1802 | 1801 | — |
| Std. Dev. | 1.74 | 25.6 | 1.8 | 0.9 | 1.0 | 1.2 | 1.1 | — |

VW-1 Analysis:

| | | | | | | | | |
|---|---|---|---|---|---|---|---|---|
| Total Flame | — | 64.1 | 60.0 | 71.3 | 55.6 | 63.0 | >60 | 60 |
| Duration (sec) | | | | | | | | |
| Ignite Cotton | 3/3 | 2/4 | 3/3 | 3/3 | 2/4 | 2/2 | 2/2 | 2/2 |
| (#yes/total) | | | | | | | | |
| Average | 0 | 53 | 0 | 0 | 33 | 0 | 0 | 0 |
| Uncharred (mm) | | | | | | | | |
| Pass/Fail | Fail | Fail | Fail | Fail | Fail | Fail | Fail | Fail |

T&E Analysis:

| | | | | | | | | |
|---|---|---|---|---|---|---|---|---|
| Average Peak | 1611 | 1891 | 1981 | 1764 | 1801 | 1807 | 1758 | — |
| Stress (psi) | | | | | | | | |
| Average | 24 | 50 | 51 | 21 | 44 | 25 | 23 | — |
| Elongation at | | | | | | | | |
| Break (%) | | | | | | | | |
| Average Secant | 23908 | 27698 | 27797 | 29665 | 17993 | 28884 | 28935 | — |
| Modulus (psi) | | | | | | | | |
| Hot Creep (%) | — | — | 12.87 | — | 13.75 | — | 19.53 | — |

Wet IR on 30 mil wires at 75° C.:

| 1 Day | — | 1.52 | 1.54 | 1.10 | 1.39 | 1.34 | 1.28 | — |
|---|---|---|---|---|---|---|---|---|
| | | E+10 | E+10 | E+10 | E+10 | E+10 | E+10 | |
| 7 Days | — | 1.13 | 4.60 | 5.61 | 6.41 | 5.65 | 5.17 | |
| | | E+10 | E+09 | E+09 | E+09 | E+09 | E+09 | |
| 14 Days | — | 9.13 | 8.91 | 5.87 | 8.19 | 9.11 | 8.69 | — |
| | | E+09 | E+09 | E+09 | E+09 | E+09 | E+09 | |
| | CS | CS | CS | CS | CS | CS | CS | CS |
| | 9 | 10 | 11 | 12 | 13 | 14 | 15 | 16 |
| Molar Ratio | 8.57 | 2.86 | 1.71 | 0.94 | 0.47 | 0.31 | 1.22 | 1.22 |
| Sb/Br | | | | | | | | |
| Combined wt % | 40 | 40 | 40 | 17.5 | 25 | 32.5 | 24 | 32 |
| of Sb and Br | | | | | | | | |
| flame retardant | | | | | | | | |

Crush Analysis:

| | | | | | | | | |
|---|---|---|---|---|---|---|---|---|
| Avg. Crush, lbf | — | — | — | — | — | — | — | — |
| Std. Dev. | — | — | — | — | — | — | — | — |

VW-1 Analysis:

| | | | | | | | | |
|---|---|---|---|---|---|---|---|---|
| Total Flame | 60 | 60 | 65.5 | 62 | 100.3 | 61 | 90.5 | 60.5 |
| Duration (sec) | | | | | | | | |
| Ignite Cotton | 2/2 | 2/2 | 3/6 | 2/2 | 3/3 | 2/2 | 2/2 | 2/2 |
| (#yes/total) | | | | | | | | |
| Average | 0 | 0 | 47 | 0 | 93.3 | 0 | 0 | 0 |
| Uncharred (mm) | | | | | | | | |
| Pass/Fail | Fail | Fail | Fail | Fail | Fail | Fail | Fail | Fail |

T&E Analysis:

| | | | | | | | | |
|---|---|---|---|---|---|---|---|---|
| Average Peak | — | — | — | — | — | — | — | — |
| Stress (psi) | | | | | | | | |
| Average | — | — | — | — | — | — | — | — |
| Elongation at | | | | | | | | |
| Break (%) | | | | | | | | |
| Average Secant | — | — | — | — | — | — | — | — |
| Modulus (psi) | | | | | | | | |
| Hot Creep (%) | — | — | — | — | — | — | — | — |

Wet IR on 30 mil wires at 75° C.:

| | | | | | | | | |
|---|---|---|---|---|---|---|---|---|
| 1 Day | — | — | — | — | — | — | — | — |
| 7 Days | | | | | | | | |
| 14 Days | — | — | — | — | — | — | — | — |

The results provided in Tables 3 and 4, above, demonstrate that the moisture-crosslinked compositions of the present disclosure have unexpectedly superior flame-retardant performance when having a combined content of antimony trioxide and polymeric brominated flame retardant of greater than 35 weight percent and a molar ratio of antimony to bromine (Sb/Br) of at least 0.79 and less than 1.71. Or, when the Sb/Br ratio is less than 0.79 and in a combined weight ratio of 35 wt %, the presence of zinc oxide provides a composition having superior flame retardance.

1. A moisture-crosslinkable composition, comprising, in weight percent (wt %) based on the total weight of the composition:
(a) 25 to 75 wt % alkoxysilane functionalized ethylenic polymer;
(b) 5 to 70 wt % polymeric brominated flame retardant having a weight average molecular weight (Mw) at least 1,000 grams per mole (g/mol);
(c) 5 to 70 wt % antimony trioxide; and
(d) 0.01 to 20 wt % silanol condensation catalyst,
wherein the polymeric brominated flame retardant and the antimony trioxide are present in quantities sufficient to provide a molar ratio of antimony to bromine (Sb/Br) in the range of from 0.79 to 1.70,
wherein the polymeric brominated flame retardant and the antimony trioxide are present in the composition in a combined amount of greater than 35 wt %.

2. The moisture-crosslinkable composition of claim 1, wherein the alkoxysilane functionalized ethylenic polymer is at least one of an ethylene-silane reactor copolymer or a silane-grafted ethylenic polymer

3. A moisture-crosslinkable composition, comprising, in weight percent (wt %) based on the total weight of the composition:
(a) 20 to 75 wt % ethylenic polymer;
(b) 0.3 to 5 wt % graftable silane-containing compound;
(c) 0.02 to 1.0 wt % peroxide initiator;
(d) 5 to 70 wt % polymeric brominated flame retardant having a weight average molecular weight (Mw) at least 1,000 grams per mole (g/mol);
(e) 5 to 70 wt % antimony trioxide; and
(f) 0.01 to 20 wt % silanol condensation catalyst,
wherein the polymeric brominated flame retardant and the antimony trioxide are present in quantities sufficient to provide a molar ratio of antimony to bromine (Sb/Br) in the range of from 0.79 to 1.70,
wherein the polymeric brominated flame retardant and the antimony trioxide are present in the composition in a combined amount of greater than 35 wt %.

4. The moisture-crosslinkable composition of claim 3, wherein the polymeric brominated flame retardant and the antimony trioxide are present in quantities sufficient to provide a molar ratio of antimony to bromine (Sb/Br) in the range of from 0.95 to 1.22; wherein the polymeric brominated flame retardant and the antimony trioxide are present in the composition in a combined amount of at least 40 wt %.

5. The moisture-crosslinkable composition of claim 3, wherein the polymeric brominated flame retardant is present in an amount ranging from 16 to 40 wt % based on the total weight of the moisture-crosslinkable composition; wherein the antimony trioxide is present in an amount ranging from 15 to 47 wt % based on the total weight of the moisture-crosslinkable composition.

6. The moisture-crosslinkable composition of claim 5, wherein the polymeric brominated flame retardant is a brominated polyphenyl ether or brominated styrene/butadiene block copolymer, wherein the polymeric brominated flame retardant has an Mw of up to 1,000,000 g/mol.

7. The moisture-crosslinkable composition of claim 6, wherein the silanol condensation catalyst is a tin carboxylate.

8. A moisture-crosslinked composition prepared from the moisture-crosslinkable composition of claim 6.

9. A cable comprising a polymeric sheath prepared from the composition of claim 1.

10. The cable of claim 9, wherein the cable has a VW-1 flame rating.

11. A moisture-crosslinkable composition, comprising, in weight percent (wt %) based on the total weight of the composition:
(e) 25 to 75 wt % alkoxysilane functionalized ethylenic polymer;
(f) 5 to 70 wt % polymeric brominated flame retardant having a weight average molecular weight (Mw) at least 1,000 grams per mole (g/mol);
(g) 5 to 70 wt % antimony trioxide;
(h) 1 to 10 wt % of a halogen-free flame retardant other than the antimony trioxide; and
(i) 0.01 to 20 wt % silanol condensation catalyst,
wherein the polymeric brominated flame retardant and the antimony trioxide are present in quantities sufficient to provide a molar ratio of antimony to bromine (Sb/Br) in the range of from 0.66 to 1.70,
wherein the polymeric brominated flame retardant and the antimony trioxide are present in the composition in a combined amount of 35 wt % or less,
wherein the polymeric brominated flame retardant, the antimony trioxide, and the halogen-free flame retardant are present in a combined amount of greater than 35 wt %.

12. The moisture-crosslinkable composition of claim 11, wherein the alkoxysilane functionalized ethylenic polymer is at least one of an ethylene-silane reactor copolymer or a silane-grafted ethylenic polymer

13. (cancelled)

14. (cancelled)

15. (cancelled)
